(19) United States
(12) Patent Application Publication
(10) Pub. No.: US 2018/0180423 A1
(43) Pub. Date: Jun. 28, 2018

(54) SYSTEMS AND METHODS FOR INDIVIDUALIZED ROUTE MANAGEMENT WITH A MACRO MANAGED TRAFFIC INFRASTRUCTURE

(71) Applicants: Richard G. J. Baverstock, Gilroy, CA (US); Robert E. Calon, Portland, OR (US)

(72) Inventors: Richard G. J. Baverstock, Gilroy, CA (US); Robert E. Calon, Portland, OR (US)

(21) Appl. No.: 15/829,962

(22) Filed: Dec. 3, 2017

Related U.S. Application Data
(60) Provisional application No. 62/439,810, filed on Dec. 28, 2016.

(51) Int. Cl. G01C 21/34; G08G 1/01; G01C 21/20; G01C 21/36

(52) U.S. Cl. CPC G01C 21/343; G08G 1/0125; G01C 21/3617; G01C 21/20; G01C 21/3492; G08G 1/0116

(57) ABSTRACT

A centralized, customizable, interconnected traffic routing system receives at least one data set, wherein the at least one data set pertains to the spatially local transportation infrastructure. The routing system receives at least one route definition from a user, and at least one route constraint from the user. The traffic routing system provides the user with an individualized transportation route with respect to at least one of the at least one route definitions and the at least one route constraint, wherein the transportation route is cohesive with a macro scale transportation solution. The system optionally provides the user an adjusted individualized transportation route in response to a change in at least one route constraint or in response to a change in the at least one data set.

### CROSS REFERENCE TO RELATED APPLICATIONS

This non-provisional application claims the benefit of U.S. provisional application No. 62/439,810, filed Dec. 28, 2016, entitled “Systems and Methods for Dynamically Optimizing Vehicular Efficiency”, which application is incorporated herein in its entirety by this reference.

This application is related to co-pending and concurrently filed U.S. application Ser. No. 15/829,960, entitled “Systems and Methods for Realtime Macro Traffic Infrastructure Management” (Attorney Docket Number MGL-1701), which application is incorporated herein in its entirety by this reference.

### BACKGROUND

The present invention relates to systems and methods for centralized traffic management and connectivity on a city or state basis. Currently, there is no solution to connect navigation solutions to city or state wide transportation infrastructure where the infrastructure may be able to make decisions and change its layout based on the real-time traffic situation, nor is there a solution to allow regulations or changes in regulations to be implemented on a city or state wide basis in real time. Additionally, there is currently not solution for a centralized traffic management that may make pre-emptive changes to the transportation infrastructure based on traffic predictions or current traffic conditions.

It is therefore apparent that an urgent need exists for a Mogol Connected Traffic Management System, a central traffic management system connected on a city wide level. The Mogol CTM allows messages to be directly delivered to vehicles and drivers via in vehicle displays and navigation instructions, and receives telemetry data from the vehicle for automatic traffic management, road usage, road condition and incident reporting. This improved traffic management system is a communications agnostic, top down, centralized, Traffic Management System which enables navigation companies to coordinate with cities on a total infrastructure wide basis to provide a unified traffic solution.

### SUMMARY

To achieve the foregoing and in accordance with the present invention, systems and methods for dynamic, interconnected traffic routing serving one or more users is provided.

In one embodiment, a centralized, customizable, connected traffic routing system receives at least one data set, wherein the at least one data set pertains to the spatially local transportation infrastructure. The routing system receives at least one route definition from a user, and at least one route constraint from the user. The traffic routing system provides the user with an individualized transportation route with respect to at least one of the at least one route definitions and the at least one route constraint, wherein the transportation route is cohesive with a macro scale transportation solution. The system optionally provides the user an adjusted individualized transportation route in response to a change in at least one route constraint or in response to a change in the at least one data set.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 depicts a system level overview of how the Mogol CTM System may be coupled via a Wide Area Network to a plurality of data input and output resources;

FIG. 2 depicts a possible diagram for information flow through the Mogol CTM System including possible input data sources and output data resources;

FIG. 3 depicts a possible diagram for information flow through the Mogol Insight Big Data Engine including the possible input data streams, and the Output Data from the Big Data Engine. Where the input data streams may include data sources;

FIG. 4 depicts a possible diagram for information flow from a Map and State database and its internal components to the internal components (a Trigger Monitor and a Response Manager of a Response Engine; and

FIG. 5 depicts a possible diagram for the internal architecture of a Response Engine, which may include a Trigger Monitor, a Response Manager, Response Plans and the equations to activate and de-activate Response Elements in reaction to Trigger Elements.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for a Mogol Connected Traffic Management System (CTM) 110. In particular, the present invention is directed to the novel methods and systems that connect infrastructure and vehicle information to a centralized, real-time, traffic management system to provide a city wide traffic management solution.

Additionally, the present invention is directed to the novel methods and systems that enable the traffic management solution to send real time data directly to customers instead of displaying limited amounts of information in discrete locations with low visibility and permeability to drivers and vehicles.

Additionally the present invention is directed to the novel methods and systems that allow for the inclusion of 3^{rd} party information and data into the real time, top-down, traffic management solution.

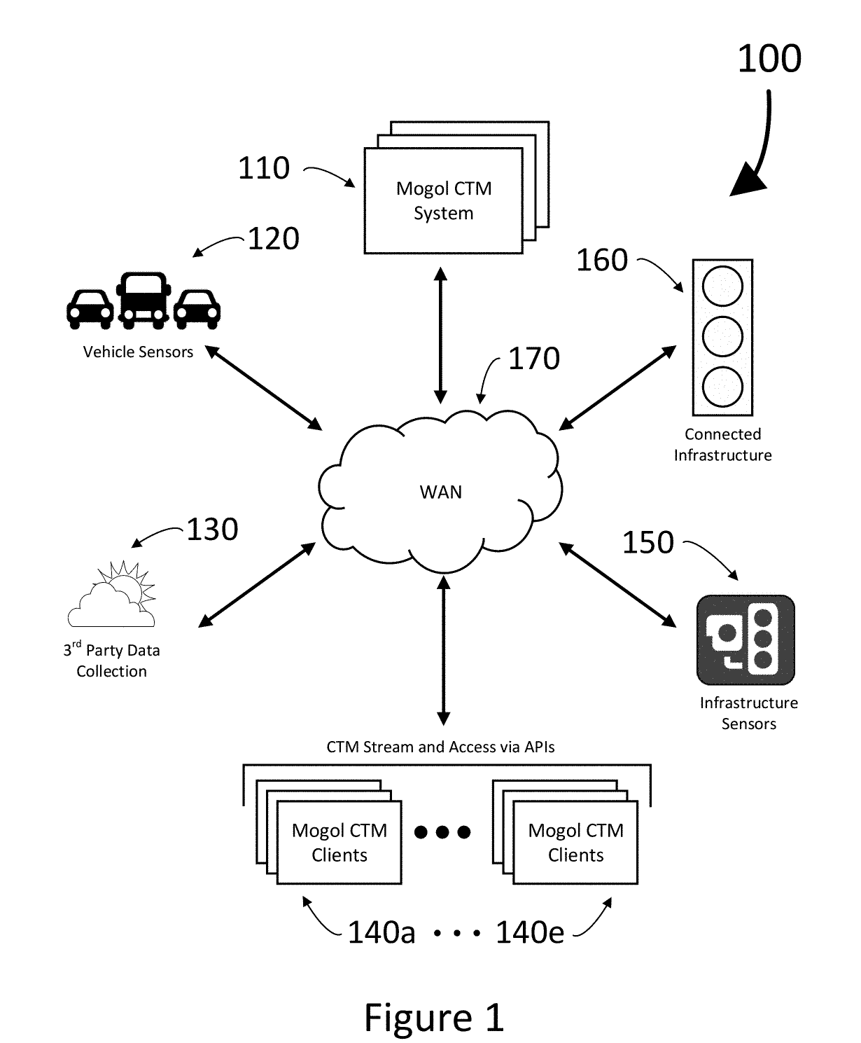

To facilitate discussion, FIGS. 1 through 5 are provided. This description section will reference these figures often. These figures are merely exemplary for the aid of describing the current invention, and are not mean to limit the scope of the present invention.

### System Overview

FIG. 1 shows how the Mogol CTM System 110 may interact with a connected infrastructure to manage the traffic in a geographical location. The Mogol CTM System 110 may collect data from a plurality of sources throughout the area being managed via any number of Wide Area Networks (WAN) 170. The data collection sources should not be limited spatially to the area being managed. An example of this would be the flux of traffic through a free-way onramp in City B, which is a full city away from City A that is being managed by the Mogol CTM System 110, may be included in the data for City A even though it is not spatially located within City A. As a result of data collected from sources including but not limited to vehicles, infrastructure, and 3^{rd} Party sources, the Mogol CTM System 110 may provide a real-time traffic management solution to subscribed clients via the Mogol CTM Stream 110.

Infrastructure may be defined as anything used in transporting from one place to another. This may include roads and road segments of any kind, including but not limited to, county roads, interstates, highways, on ramps, off ramps, toll ways, bridges, tunnels, surface streets, and private roads. Additionally, infrastructure may include street lights (stop lights), metering lights, and control lights. Additionally, infrastructure may include high occupancy vehicle lanes (HOV), carpool lanes, bus and or other public transportation lanes, bicycle lanes, and pedestrian lanes. Additionally, infrastructure may include any sensors, static or dynamic signage, digital message signs, active traffic management systems or traffic control systems, regions of restricted operation, access or usage (e.g. variable speed limits, or lane closure management), or detours. Infrastructure may include public and private modes of transportation, including but not limited to, trains, busses, carpools, metros, light rails, hyperloops, and other “people mover” like transportation modes.

An example of how the system may function may include that the Mogol CTM System 110 identifies an increase in traffic concentration on a stretch of road, and outputs via the Mogol CTM Stream 110 that a new lane should be created on that same stretch of road to alleviate the congestion. Additionally, the Mogol CTM System 110 may directly implement real time traffic infrastructure alterations as a result of collected and processed data. An example of this may include the Mogol CTM System 110 creating a region of reduced speed via an advised speed or variable speed limit to prevent collisions during congestion or poor weather conditions via the connection between the Mogol CTM System 110 and the Connected Infrastructure 160. The Mogol CTM system 110 may then display the changes on navigation or information displays in connected vehicles. This may include changing the displayed speed limit on a navigation unit of a connected vehicle, and alerting the driver to the change in speed limits on an information display unit in the instrumentation cluster of the vehicle. Additionally, the driver may be alerted to the additional lane creation via a display unit including, but not limited to a navigation unit. The displaying of changes should not be limited to the above mentioned examples, additional examples may include notifying the driver to a change in the number of passengers need to qualify as a carpool or high occupancy vehicle, or a change in the toll cost for a section of road or a bridge. In the case of the driver using a mobile device to connect to the Mogol CTM system 110, the Mogol CTM system 110 may display the above mentioned changes or alterations on the mobile device. The mobile device may include but is not limited to, telephones, tablets, computers, and stand-alone navigation units.

The Mogol CTM System 110 may use vehicles, vehicle sensors 120, and vehicle information displays as integral pieces in the Mogol CTM System 110. The Mogol CTM System 110 may collect data from the connected vehicles and their sensors 120, additionally the vehicle's GPS data may be collected. The Mogol CTM System 110 may use connected vehicle's as sensors to aid in dynamic traffic management. The Mogol CTM System 110 may also use information displays within connected vehicles. This may include displaying static or dynamic information on in-vehicle information displays, including but not limited to, infotainment screens/displays, navigation unit screens/displays, head's up displays (HUDs), dashboard information displays screens, and rear view camera display screens/displays. The Mogol CTM System 110 may also display static or dynamic information on a connected user device including but not limited to, computers, smart phones, and tablets. The static and/or dynamic information may include but is not limited to information pertaining to the vehicle, the current or future road conditions on a route, traffic conditions, public and/or private transportation arrival and departure schedules, 3^{rd} party data, or connected traffic infrastructure information.

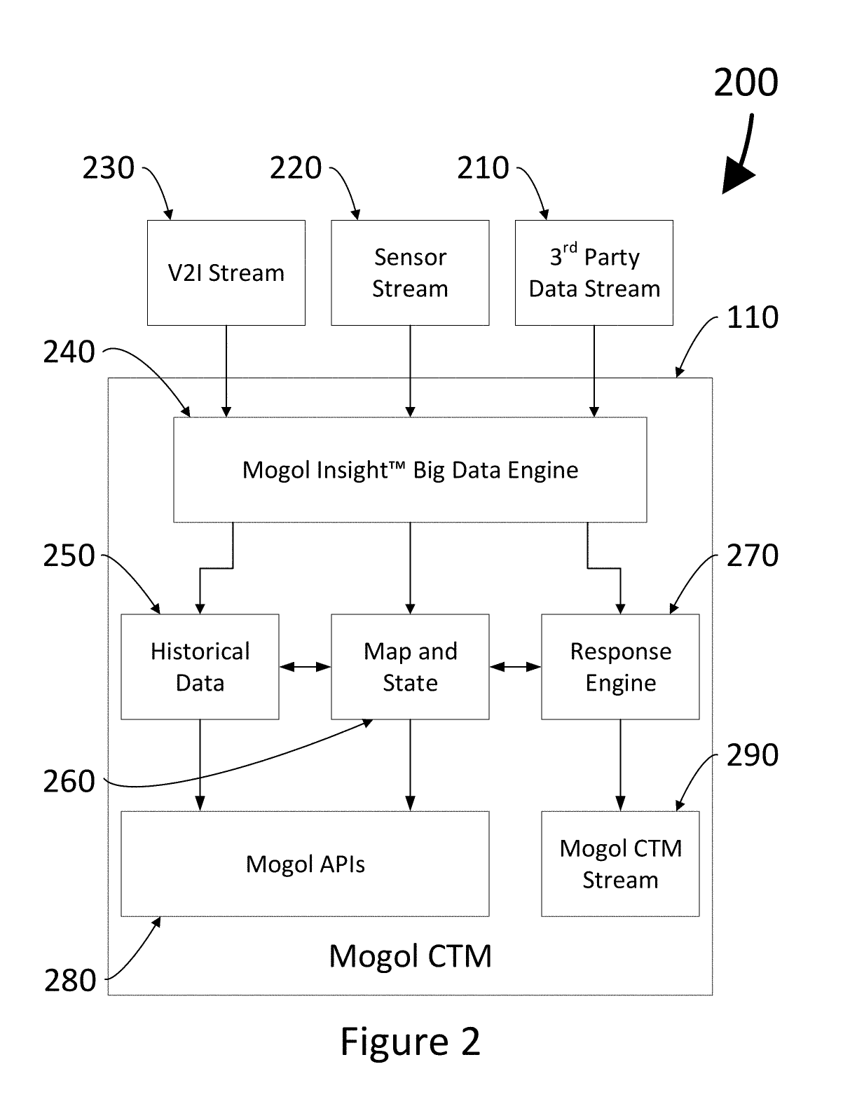

FIG. 2 shows a high level block diagram of the Mogol Connected Traffic Management System. Data may be passed from external data streams 210, 220, 230 into the Mogol Big Data Engine 240, where it may be processed, and the processed outputs may be passed to multiple blocks within the Mogol CTM System 110. The data may be passed into a Response Engine 270, where the data in conjunction with pre-defined settings from a Map and State block 260 may cause certain responses to be triggered. The output from the Response Engine 270, asserted and de-asserted responses may be output to a Mogol CTM Stream 290, where it may be delivered to subscribing customers. Additionally, the outputs from the Response Engine 270 may flow into the Map and State 260 where they may be accessible to an end user via Mogol APIs 280. The Map and State block 260 may contain data corresponding to the current state of the infrastructure and traffic flow of the managed area, data corresponding to a map of the managed area, and data corresponding to the settings that configure the Response Engine 270. The outputs from the Big Data Engine 240, and the Response Engine 270, and data from the Map and State block 260 may be polled or sent to a Historical Data database 250 for archiving. The archived data may be accessible to an end user via Mogol APIs 280.

FIG. 2 shows data collected from a plurality of sources which include but are not limited to a Vehicle to Infrastructure data Stream 230, a Sensor data stream 220, and a 3^{rd} Party data stream 210. The data streams should not be limited to those listed above, and none of the streams listed above should be considered mandatory.

FIG. 2 shows the data streams 210, 220, 230, as described above, as inputs to the Mogol Insight Big Data Engine 240. The output data stream from the Big Data Engine 240 may be used as inputs to multiple software or hardware blocks, including but not limited to a Historical Data database 250, a Map and State database 260, and a Response Engine 270. The data from the Big Data Engine 240 may be used as inputs to other modules, and may not necessarily be used as an input to the modules listed above.

FIG. 2 shows a Map and State block 260 in the Mogol CTM System. This block may hold the current state of the managed area, a map of the managed area, and the description and configuration settings for the Response Engine 270. Inputs into Map and State 260 may include but is not limited to, data from the Big Data Engine 240, response outputs from the Response Engine 270, and data from the Historical Data database 250. The Map and State block may pass data to the Response Engine 270 and the Historical Data database 250. The data contained in Map and State 260 may be accessed by an end user via a Mogol API 280.

FIG. 2 shows a Response Engine 270. The Response Engine 270 may evaluate expressions to determine response outputs based on input data from the Big Data Engine 240, historic data from the Map and State block 260 and configuration descriptions from the Map and State block 260. The output responses from the Response Engine 270 may be pushed to an end user via a Mogol CTM Stream 290, which could be used by the user to manipulate traffic infrastructure in the managed area. The Response Engine 270 may take data as inputs from the Big Data Engine 240 and Map and State 260. Output responses to Map and State 260 and a Mogol CTM Stream 290.

FIG. 2 shows a Historical Data database 250. The Historical Data database 250 may collect “snapshots” of the system in discrete increments. These snapshots may include data from the Big Data Engine 240 as well as the Map and State database 260. The system snapshots may be collected at discrete increments of 1 minute between samples. The data stored in the Historical Data database 250 may be accessed by an end user via a Mogol API 280.

### Input Data Streams

FIG. 1 shows a plurality of data sources 120, 130, 150 that may connect to the Mogol CTM System 110 via a Wide Area Network (WAN) 170. FIG. 1 should not limit the possibility of multiple WANs from being used by the Mogol CTM System 110 to manage traffic in an area. The Mogol CTM System 110 may collect data from a plurality of sources separated spatially by large or small distances relative to the connectivity range of any given communications method. Due to the spatial diversity of data sources, a plurality of communications methods may be used to collect data. Data collection methods and networks may include but are not limited to, Cellular 4G LTE, 4G, and 3G networks; WiFi networks; DSRC; Bluetooth; XBee frequencies; Zigbee frequencies; and custom communications protocols. The communication of data may use wireless, wired or a combination of both wired and wireless communication protocols and methods.

FIG. 1 shows vehicles and vehicle sensors 120 connected to the WAN 170 that is used by the Mogol CTM System 110 to collect data. The vehicles and vehicles sensors 120 may use a plurality of communications methods to send and receive data via a WAN 120. The vehicle sensors may include OEM (Original Equipment Manufacturer) sensors, and after-market installed sensors. The method of data communication from the vehicles and vehicle sensors 120 may include OEM communications methods, and after-market installed communications methods. An example of this may be a communications started used by the Mogol CTM System 110 to better communicate only the information needed by the Mogol CTM System 110.

FIG. 2 shows three data source blocks 210, 220, 230 contributing data to the Big Data Engine 240. As described above, the Mogol CTM System 110 may collect data from a plurality of sources. The data from these sources may come into the Mogol CTM System 110 via input data streams. The three possible streams 210, 220, 230 shows in FIG. 2 are a very small representation of the possible number of input data streams from connected data sources. These streams may come from a plurality of sources via a plurality of communications methods and may include but are not limited to a Vehicle to Infrastructure data stream 230, a Sensor data stream 220, and a 3^{rd} Party data stream 210. The purpose of the data collected by the Big Data Engine 240 is to reconstruct the current state of traffic within the monitored area. To do this, the Mogol CTM System 110 may collect data from a plurality of sources that differ in types of data collected, method of reporting, and location in the monitored area.

The Mogol CTM 110 may collect data from the infrastructure currently being managed. Infrastructure sensors may sense directly, or they may communicate with other entities (including vehicles) to widen the data collection range. Possible infrastructure sensors may include but are not limited to, embedded loop road sensors, microwave vehicle detection systems, and CCTV vehicle identification.

An example may include the collection of data from infrastructure sensors 150 including road loop sensors, traffic light cameras and vehicle counting systems. Using all of this data, the Big Data Engine 240 may construct the traffic density and flow rate through a particular intersection. Using this as well as loop sensors, traffic light timing sensors, and vehicle positions from 3^{rd} Party GPS systems, the Big Data Engine 240 may construct the current traffic picture and predicted picture of traffic flow through five consecutive intersections including the predicted delays due to necessary red lights, the average number of vehicles through a green light, and the number of vehicles on the mentioned stretch of road. While the Mogol CTM 110 may operate by collecting data from a plurality of sources, it may also operate by collecting data from only vehicle GPS.

### Big Data Engine

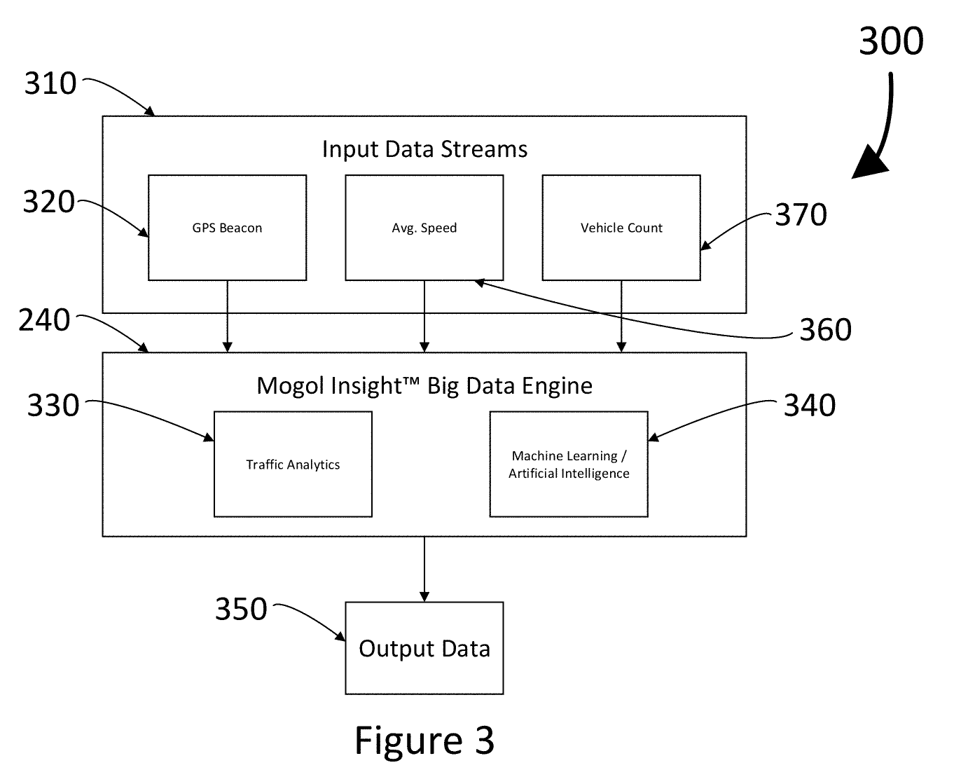

FIG. 3 shows an example of how the Mogol Insight Big Data Engine 240 and the input data streams 310 may interact. The input data streams 310 may contain a plurality of data sources. To illustrate this, the data sources illustrated in FIG. 2 210, 220, 230 are different than those illustrated in FIG. 3 320, 360, 370. The types of data shown in the input data streams from FIGS. 2 and 3 should not limit the types of data possible. FIG. 3 depicts three possible data sources 320, 360, 370 as part of the input data streams 310. One possible data source may be a GPS Beacon stream 320. This type of data may be its own stream as depicted in FIG. 3, or it may be included in a Vehicle to Infrastructure stream 230 as depicted in FIG. 2. FIG. 3 depicts two other possible data sources 360, 370 that may be included in the input data stream 310.

FIG. 3 depicts an example of how the input data streams 310 may be used as inputs to the Big Data Engine 240. The Big Data Engine 330 may have two functional blocks 330, 340 that may allow the Big Data Engine 240 to process the input data for the Mogol CTM System 110. The Big Data Engine 240 may use a Traffic Analytics block 330 and a Machine Learning or Artificial Intelligence block 340 to process the input data streams 310 data.

The input data streams 310 to the Big Data Engine 240 may provide discretized data points to the Big Data Engine 240, where the Big Data Engine may analyze the discretized data on a sample by sample basis. The samples may be associated with a segment of road, or the Big Data Engine 240 may associate a sample with a given segment of road. The sample may include information to identify the road and position on the road in the Map and State 260 database. The sample may include additional associated data including but not limited to speed, vehicle count, acceleration, and incident warnings. The Big Data Engine 240 may use any, all, or none of the information associated with an input data sample during data processing. The Big Data Engine 240 may process input data samples based on their associated road segment. From this processing, the Big Data Engine 240 may produce conclusions for a road segment, which may include but is not limited to the traffic speed on a road segment, and the vehicle count on a road segment. These conclusions may be the output data 350 from the Big Data Engine 240.

The processing of data by the Big Data Engine 240 may be accomplished using a distributed processing cluster.

The Big Data Engine 240 may use a Traffic Analytics block 330 to analyze incoming data to the Big Data Engine 240.

The Big Data Engine 240 may use a Machine Learning/Artificial Intelligence block 340 to aid in the processing of the incoming data to the Big Data Engine 240. The ML/AI (Machine Learning/Artificial Intelligence 340 may have its own data in the Output Data 350 from the Big Data Engine 340. The ML/AI 340 may aid the Traffic Analytics block 330 in processing incoming data to the Big Data Engine 240. An example of the ML/AI 340 contributing its own data in the Output Data 350 may include, the ML/AI 340 identifying the same pattern in traffic processed by the Traffic Analytics block 330 for three consecutive days at approximately the same time of the day, and predicting this behavior on the fourth day prior to the Traffic Analytics block 330 processing the data. The ML/AI 340 may output the prediction of the traffic pattern before Traffic Analytics 330 processes the pattern. The ML/AI 340 may then refine the timing of the traffic pattern prediction based on when the Traffic Analytics 330 processes the traffic pattern.

The Big Data Engine 240 may use the processed conclusions in conjunction with the ML/AI 340 to output an action. An example of this may include the Big Data Engine 240 changing the speed limit of a road segment from 45 mph (miles per hour) to 35 mph based on traffic count or traffic speed conclusions from the processed data. In this way, Mogol CTM System 110 may change the transportation infrastructure without the change contained in a Response Plan 510, 520, 530. This may allow the Mogol CTM System 110 to change the transportation infrastructure more efficiently without be constrained to only changes defined by the Response Plans 510, 520, 530.

FIG. 3 shows Output Data 350 from the Big Data Engine 240. This data may be used in a plurality of places, including but not limited to, being stored in a Historical Data database 250; a Map and State block 260; and a Response Engine 270, as shown in FIG. 2.

### Map and State

FIG. 2 shows that a Map and State block 260 may be included in the Mogol CTM System 110. Map and State 260 may use the Output Data 350 from the Big Data Engine 240. Map and State 260 may also use data from and provide data to a Historical Data database 250 and a Response Engine 270.

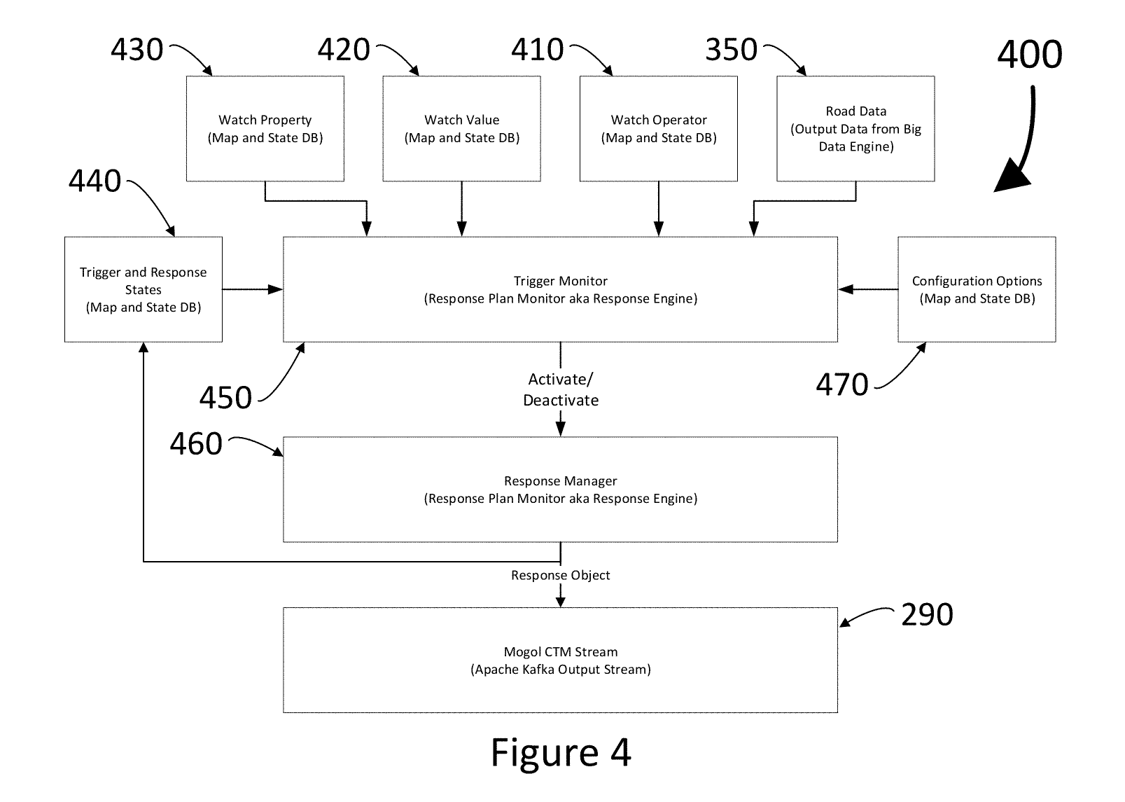

FIG. 4 shows a block diagram for a possible configuration of a Map and State block 260 may interact with a Response Engine 270. The Map and State 260 may contain and provide a plurality of triggers to the Response Engine 270. This trigger may include, but is not limited to a Watch Operator 410, a Watch Value 420, and a Watch Property 430. The Map and State 260 may provide additional Configuration Options 470 to the Response Engine 270. The Map and State 260 may also provide the Trigger and Response States 440 for the defined triggers and responses define in the Response Engine 270.

The Map and State 260 may provide watch handles 410, 420, 430 for each of the triggers defined in the Response Engine 270, or triggers may share watch handles 410, 420, 430. Additionally, there may be multiple watch handles 410, 420, 430 for each trigger.

The Map and State 260 may provide additional Configuration Options 470 for each of the triggers, or triggers may share additional Configuration Options 470. Certain triggers may not need or have associated with them Configuration Options 470.

The Map and State 260 may provide the current Trigger and Response States 440 for each of the triggers and responses defined in the Response Engine 270. Additionally, the Map and State 260 may provide Trigger and Response States 440 for only some or none of the triggers and responses defined in the Response Engine 270. The Map and State 260 may provide Trigger and Response States 440 to a Historical Data database 250 for archiving and storage purposes. The Map and State 260 may provide Trigger and Response State 440 data to a Historical Data database 250 in discrete time intervals, where the time intervals may include but are not limited to 1 minute, 1 hour, 1 day, 1 week, 1 month, and 1 year. Additionally, the Map and State 260 may store a map network database. The map network database may be used by multiple portions of the Mogol CTM System 110.

### Response Engine

As described above, FIG. 4 depicts a possible block diagram for how configuration data from Map and State 260 and the Response Engine 270 may interact to produce the Mogol CTM Stream 290. The Response Engine 270 may include a Trigger Monitor 450, and a Response Manager 460. The Trigger Monitor 450 may contain the trigger information from Map and State 260. The Response Manager 460 may contain the response information from Map and State 460.

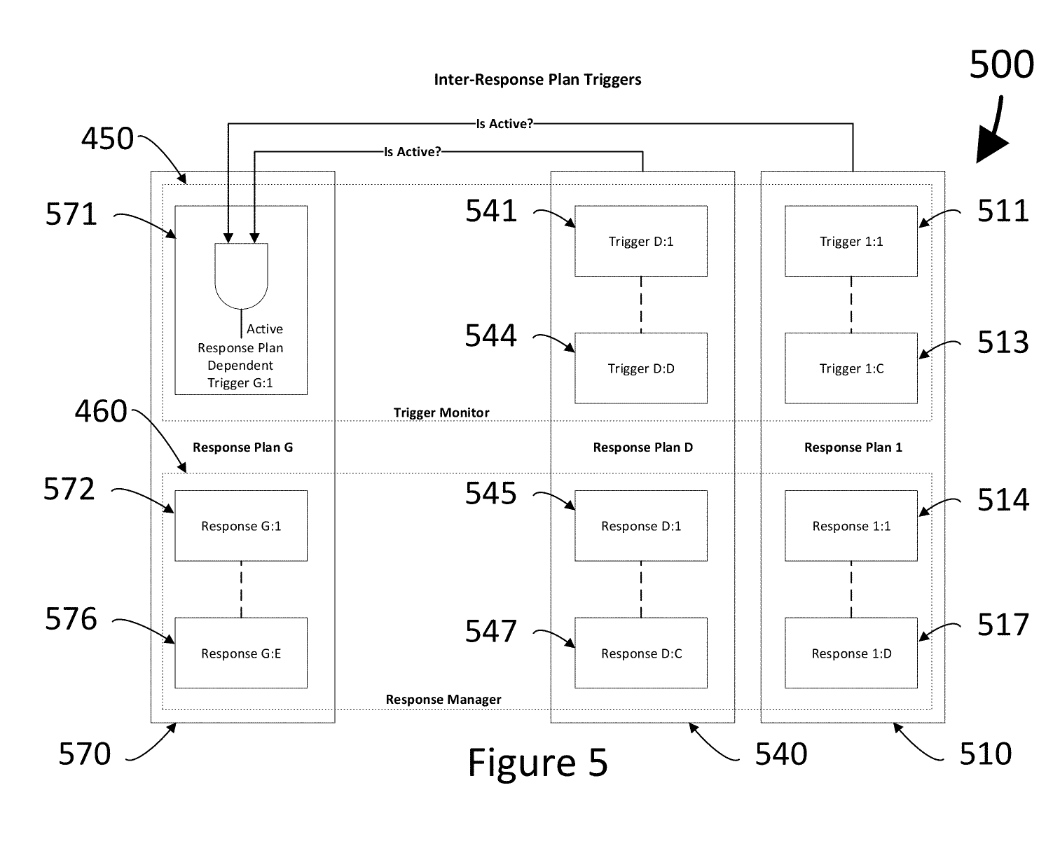

FIG. 5 depicts the block diagram and high level view of the Response Engine 270, also referred to as the Response Plan Manager 270. In this application, this block of the present invention is referred to as the Response Engine 270, however this does not limit any functionality of this block from including that described by the Response Plan Manager 270. The Response Engine 270 comprised of Response Plans 510, 520, 530. In the example depicted in FIG. 5, the Response Engine 270 is built using Response Plans 1, M and P 510, 520 and 530. The Response Engine 270 may be built using any number of Response Plans 510, 520, 530, and while FIG. 5 shows the Response Engine 270 being built with three Response Plans 510, 520, 530, this should not limit the possibilities for building a Response Engine 270.

As shown in FIG. 5, each Response Plan 510, 520, 530 contains Trigger Elements. The Trigger Elements for Response Plan 1 are Trigger 1:1 through Trigger 1:C 511 through 513. Response Plan D contains Trigger Elements D:1 through D:D 541 through 544. Response Plan G contains a single Trigger Element G:1 571. A Response Plan may contain any number of Trigger Elements.

As shown in FIG. 5, each Response Plan 510, 540, 570 contains Response Elements. The Response Elements for Response Plan 1 are Response 1:1 through Response 1:D 514 through 517. Response Plan D contains Response Elements D:1 through D:C 545 through 547. Response Plan G contains Response Elements G:1 through G:E 572 through 576. A Response Plan may contain any number of Response Elements.

As shown in FIG. 5, in addition to being a part of the Response Plans 510, 540, 570, the Trigger Elements 511, 513; 541, 544; 571 make up the Trigger Monitor 450. Likewise, in addition to being a part of the Response Plans 510, 540, 570, the Response Elements 514, 517; 545, 547; 572, 576 make up the Response Manager 460.

As shown in FIG. 5, the Trigger Elements 511, 513; 541, 544; 571 may be made up of any configuration of equations (depicted by a Boolean logic symbol). These equations may determine whether or not the Trigger Element conditions have been met. The equations may use inputs related to the input data to the Response Engine 270. As described above, this input data may be obtained via the input data stream 310. Additionally, as depicted in FIG. 5, the input to a particular Trigger Element 571, may be data from the output of a Response Plan 510, 540 from within the Response Engine 270. Trigger Elements 511, 513; 541, 544; 571 may also contain compound requirements. An example of this may be an equation being true for an elapsed period of time before the trigger element is asserted or de-asserted.

The watch handles 410, 420, 430 and the Configuration Options 470 from Map and State 260 alone or in conjunction with each other may be thought of as or considered the response plan definitions for the Response Plans 510, 540, 570 defined in the Response Engine 270. These response plan definitions may also describe the Trigger Element conditions. These Trigger Element conditions may describe the behavior of the equations that make up a Trigger Element 511, 513; 541, 544; 571.

When the conditions for a particular Trigger Element 511, 513; 541, 544; 571 is met, it may trigger the corresponding Response Element 514, 517; 545, 547; 572, 576. This may manifest itself in a flag corresponding to a particular Trigger Element being asserted or de-asserted. This flag may be used to trigger a Response Element, or as an input to any number of additional Trigger Elements in the same Response Plan or an additional Response Plan. Input conditions to Trigger Elements may be a plurality of data types, including but not limited to, time of day, week, month, year; weather conditions; current road conditions; current traffic congestion and/or flow on a segment of road; conditions/trigger flags of additional Response Plans. While a Response Plan may be tailored to a particular segment of road, the input data nor the output responses must be confined to that segment of road. An example of this may be, if traffic congestion around the capitol building reaches a pre-defined threshold, a glass lane is created on a freeway onramp three miles away. Additional input and/or output data types may include but are not limited to variable speed limits being asserted or de-asserted, glass lanes being created or destroyed, lighted traffic information signs changing outputs, freeway meter lights changing allowance frequency, signal lights changing pattern and/or duration, toll charges changing value, and city public transit units taking additional or different routes. A Trigger Element or Response Element may also be dynamically determined by the response engine based upon a pre-determined strategy with optional configuration parameters. For example, a variable speed limit strategy executed by the response engine would automatically create a traffic speed Trigger Element at a configurable offset below the speed limit, and create a Response Element with an advised or mandatory speed limit at some configurable offset from the traffic speed. The Response Element may apply to the entire road section the strategy is applied to or a subsection of the road section the strategy is applied to. Trigger Element and Response Element may be stored in local memory or stored in the Map and State database.

The configuration and decision tree logic of the Response Plans 510, 540, 570 may take any hierarchical structure. FIG. 5 depicts 2 hierarchical levels where the outputs from Response Plans 1 and D 510, 540 are elevated to the inputs of Response Plan G 570. Any number of Response Plan outputs may be used as inputs to any number of additional Response Plans. A Response Plan output does not necessarily need to be elevated; an output of a Level 2 Response Plan may be used as an input to a Level 1. An example of this would be an output from Response Plan G 570 being used as an input to either Response Plan 1 510 or Response Plan D 540. Response Plan inputs and outputs may “skip” a hierarchical level without being used in the skipped level. An example of this would be an output of Response Plan G 570 is elevated to a Level 3 Response Plan, and the output of an additional Level 1 Response Plan is elevated directly to the Level 3 Response Plan. The additional Level 1 Response plan does not have to travel through The Level 2 Response Plan G 570 before being used in the Level 3 Response Plan. FIG. 5 should not limit the configuration nor hierarchical layout of how Response Plan inputs and outputs are used by other Response Plans.

The configurations, hierarchical structure, pre-defined set points, and any other configuration or definition data and/or settings used in the Trigger Elements 511, 513; 541, 544; 571, Response Elements 514, 517; 545, 547; 572, 576, Response Plans 510, 540, 570, and/or the Response Engine 270 may be defined by Map and State 260 of the Mogol CTM System 110.

The outputs from the Response Engine 270 (flags being asserted and de-asserted, Response Plans 510, 540, 570 being activated and de-activated, Trigger Elements 511, 513; 541, 544; 571 being activated and de-activated, and Response Elements 514, 517; 545, 547; 572, 576 being activated and de-activated) may be assembled into an output data stream. This data may be sent to multiple locations. Two possible places for the output data stream to be used are the CTM Stream 290 that goes out to customers, and the Trigger and Response States block 440 within Map and State 260. These two examples of output data recipients should not limit the locations where the output data from the Response Engine 270 may go.

### Output Data

FIG. 2 depicts a high level information flow diagram. As described above, the Trigger Monitor 450 and the Response Manager 460 may be contained in the Response Engine 270. FIG. 2 shows the output of the Response Engine 270, and how it may go to multiple locations. As described above, the output from the Response Engine 270 may go to the Mogo CTM Stream 290, and/or the Trigger and Response States block 440 within Map and State 260.

The Mogol CTM Stream 290 may be in the format of a data stream, including but not limited to, Apache Kaftka and Amazon Kinesis, or it may take the format of a different or number of different data transfer formats. The Mogol CTM Stream 290 may be a push based data transfer system, where customers who subscribe to a particular Mogol CTM Stream 290 receive a continuous stream of data. Additionally, the same data presented in the Mogol CTM Stream 290 may be accessible through the Trigger and Response block 440 in Map and State 260 via a REST API 280. This REST API 280 may be a poll based data transfer system where a client may request data from the REST API 280. The data present in the Mogol CTM Stream 290 and that available via the REST API 280 may be the same data.

In addition to the Response Engine 270 output data, which may be available via the Mogol CTM Stream 290 or via a REST API 280 that accesses the Trigger and Response States block 440 within Map and State 270, Historical Data may be stored in a Historical Data database 250. This Historical Data may be a discretized version of the Mogol CTM Stream 290, where the Historical Data may be discretized in 1 minute intervals. The Historical Data may also contain the output from the Mogol Big Data Engine 240. The Historical Data may be a discretized version of the output from the Big Data Engine 240. The Historical Data database 250 may be accessed through Map and State 260 via a REST API 280, similar to accessing the Response Engine 270 output data. Additionally, the Historical Data may be accessed via an API directly through the Historical Data base 250.

### Trip Tracking/Reconstruction

As described above, one of the possible sources of input data streams 310 may include a GPS Beacon 320. This beacon information may include the associated of the location of a vehicle with a roadway or roadway segment. In this way, the Mogol CTM System 110 may track the movement of a vehicle as the vehicle moves through the transportation infrastructure. The association of a vehicle with a road segment may be accomplished using a plurality of methods combined with each other or stand alone. One of these methods may include computing the distance and bearing differences of GPS Beacon 320 data points as compared to the known locations of nearby roads and selecting the road segment with the least associated bearing difference. Another method may include constructing a route that follows a viable, real-world path using the previous method in conjunction with beacon data points.

An example of location reconstruction may include, a vehicle entering a highway from an arterial roadway. The routes from the arterial roadway onto the highway may include two possibilities, a general purpose lane and a toll lane. GPS Beacon 320 data points associated with the location of the vehicle are received from the arterial road, the on ramp, and the highway. The GPS Beacon 320 data points may not have a high enough resolution to determine if the vehicle used the general purpose on ramp lane or the toll on ramp lane to enter the highway. The GPS Beacon monitor may track the vehicle's beacon data points, noting the on ramp it detected the vehicle on, and make a determination of on ramp usage based on travel history. If a determination is not possible based on travel history, the options may be stored until the next GPS Beacon 320 data point is received. Based on this received data point, the road segment's connectivity may be used to determine which previous road segments are not possible. This may be done via a connectivity check using a road network graph, or via one or multiple routing algorithms including but not limited to Dijkstra or A*. If a previous road segment is reduced, the beacon monitor may continue back tracking and reducing in a similar manner until a previous road segment is found with only one option, or the beginning of the trip is reached.

The GPS Beacon monitor may also provide responses and data to the vehicle. These responses and data may indicate the roads the vehicle is likely on as well as notifications for traffic management on the current roadways or roadways ahead. This data may be in conjunction with data from the Map and State 260.

### Trip Tolling

The Mogol CTM System 110 may track and accumulate tolling totals for a vehicle. The Mogol CTM System 110 may report a toll total via an output data stream 290, or to a 3^{rd} Party. The data associated with the toll total may be used for billing, accounting, processing or debiting from an existing account. A toll total may be calculated using a plurality of methods. One method may include, storing the origin and destination of on ramps and/or lane change areas along a highway or road segment. This data may be stored in the Map and State 260 database. During the trip of a vehicle, if it is detected to be passing through a toll origin or toll destination segment, the vehicle status may change from tolling to non-tolling, or from non-tolling to tolling. Upon completion of the trip, the number of origin and destination pairs may be stored and may be transferred to the output data stream for processing, billing and/or accounting. In addition to the number of origin and destination pairs, the locations of the origins and destinations as well as timestamps for origin and destination crossings may be part of the output tolling data. The locations and timestamps may be used to determine where the toll was incurred, and at what time the toll was incurred.

### ADDITIONAL DESCRIPTION/EMBODIMENTS

While the above paragraphs disclose the possibility of traffic management of vehicles using a Mogol CTM System 110 where vehicles may include but are not limited to automobiles, busses, motorcycles, and scooters, the possibility of management for other types of transportation should not be excluded. The Mogol CTM System 110, its sensors, data process and data outputting may also be applied but is not limited to trams, trollies, trains, subways, taxis, rideshares, and bicycles. An example of this may be, using the Mogol CTM System 110, a client receiving a Mogol CTM Stream 290 sees a route may be more efficient if a mode of public transportation is taken, or a bicycle is taken. Clients 140a . . . 140e or users of the clients may decide to take an alternate mode of transportation in lieu of the automobile they were planning to use.

The Mogol CTM System 110 may management the movement of public transportation infrastructure including but not limited to busses, taxis, subways, trams, trains, and trollies. An example of this may include the Mogol CTM System 110 identifying every weekday at 4 pm, the traffic density through a particular section of road begins to increase. Subsequently, every weekday at 4:30 pm the traffic density into the subway hub increases, and the subways heading away from the epicenter of city are all full. The Mogol CTM System 110 may include a Response Plan 510, 540, 570 whereby lane usage, including shoulder availability and turning lane assignment is optimized on the particular section of road mentioned above, and the frequency of subway trains traveling away from the city epicenter is increased when the lane optimization is in place.

Additionally, the Mogol CTM System 110 may help to manage the ridesharing resources of 3^{rd} party rideshare companies. An example of this may include the Mogol CTM System 110 identifying that approximately a half hour before the end of a home football game, the traffic density around the stadium area increases. The Mogol CTM System 110 may include a Response Plan 510, 540, 570 whereby it notifies 3^{rd} Party rideshare companies to a future uptick in requests 45 minutes before the end of a home game. In this way, the Mogol CTM System 110 may alleviate the increased density of traffic because the response time of the rideshare company has been reduced due to the preventative measure by the Mogol CTM System 110.

### Mobile Platform

The above paragraphs have described how a Mogol CTM System 110 may collect a plurality of traffic data and provide suggestions to the connect infrastructure on how to dynamically change the layout of the transportation infrastructure based on a set of Response Plan 510, 540, 570. An addition to the Mogol CTM System 110 may take the form of a route guidance system that presents information to users on technology platforms including but not limited to, smartphones, tablets, computers, vehicle navigation systems, smartwatches, and smart-wearables via applications, webpages or executables. The Mogol Navigation System may be an addition to the Mogol CTM System 110 where the Mogol Navigation System communicates with the Mogol CTM System 110 via a WAN 170.

A user may input to the Mogol Navigation System an ending destination, any number of waypoints, and a starting point, additionally the user may allow the Mogol Navigation System to use the user's current position as the starting point for navigation. The user may choose to optimize the route based on time, energy consumption, mileage, or avoiding any number of transportation occurrences (traffic, toll roads, highways, etc.). Once a route has been input to the Mogol Navigation System, the system may communicate with the Mogol CTM System (110 to compute a route that allows travel from the starting point to the ending point, going through any additional waypoints while adhering as best as possible to the constraints put on the route. Additionally, the Mogol Navigation System may compute the route without connecting to the Mogol CTM System 110.

The Mogol Navigation System may continue communications with the Mogol CTM System 110 along the navigated route to provide information including but not limited to, GPS location, speed and vehicle sensor information dealing with the surround traffic density. This data, sent by the Mogol Navigation System and collected by the Mogol CTM System 110 may be included in one or multiple input data streams 210, 220, 230 to the Big Data Engine 240. By collecting information from a plurality of Mogol Navigation Systems, the Mogol CTM System 110 may more efficiently dynamically change the transportation infrastructure to allow for a more efficient throughput of transportation vehicles.

The Mogol CTM System 110 may communicate infrastructure alterations to connected Mogol Navigation Systems. An example of this may include the Mogol CTM System 110 creating a new glass lane along a stretch of road to accommodate additional traffic throughput and notifying Mogol Navigation Systems that have or may have the above stretch of road in a navigation route. The Mogol Navigation Systems may alter their route based on this new information, or communicate the existence of a new glass lane to the user or autopilot controlling the transportation vehicle in which the particular instance of the Mogol Navigation System is in.

Additionally, the Mogol Navigation System or the Mogol CTM System 110 may archive or store the periodically taken routes by individual users. An example of this may include User 1 takes a route from his or her house in the suburbs of City A into the city center of City A every weekday morning at 6 am. The user then takes a route from the city center to his or her house every weekday evening at 5 pm. The Mogol Navigation System or the Mogol CTM System may store this information and begin to predict the traffic patterns along these used routes for times in the future. An example may be extended to a situation where half of the residents in the suburbs of City A take routes from different locations in the suburbs to different locations of the city center every weekday morning from a time of 5 am to 8:30 am. Theses residents also take routes every weekday evening from 4:30 pm to 7 pm from the same location they ended at in the morning to the same location they began at in the morning. The Mogol Navigation Systems may collect this periodic routing and communicate it to the Mogol CTM System 110, where the Mogol CTM System 110 may use this periodic routing to make preventative transportation infrastructure alterations around these times during these days of the week.

The Mogol CTM System 110 may provide a suggested departure time for a route based on the current and predicted transportation usage. An example of this may include User 1 takes a route from his or her residence to his or her work every weekday between 5 am and 5:45 am, and takes a route from his or her work back to the residence every weekday between 4:30 pm and 6:30 pm. The Mogol Navigation System used by User 1 may communicate the desired morning departure window of 5-5:45 am and the predicted route to the Mogol CTM System 110, and based on the desired departure window and route of additional users whose routes intersect User 1's route or time on the route, the Mogol CTM System 110 may suggest a departure of 5:25 am to User 1, a departure of 5:15 am to other users in the same departure window and interesting the same route and a departure time of 5:40 am to even more users in the same departure window interesting the same route. In this way, the Mogol CTM System 110 may stagger the traffic on different portions of roads throughout the managed city leading to a possible decrease in travel time for Mogol Navigation System users.

Additionally, users of a Mogol Navigation System may choose to allow their route to include public transportation systems. The Mogol Navigation System may communicate these preferences to the Mogol CTM System 110, and as a result, the Mogol CTM System may include public transportation in some users' routes while others users take a route using only a motor vehicle. In this way, the Mogol CTM System 110 may control the traffic density of motor vehicles during a given time along a given route by transferring some travels to public transportation. This may also allow the Mogol CTM System 110 to utilize public transportation system more efficiently based on time of departure of some users of a Mogol Navigation System. In addition to the possibility of more efficiently using public transportation systems, Mogol Navigation System users may experience an overall decrease in travel time, which may be an overall increase in efficiency of the city's transportation infrastructure.

In sum, the present invention provides a system and methods for dynamic traffic data collection and traffic management. The advantages of such a system include the ability to dynamically change the layout of the transportation infrastructure due to defined Response Plans and real-time Response Plan refinement due to machine learning.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized, centralized, customizable, connected traffic routing system a method for controlling a transportation infrastructure in real time on the macro scale, the method comprising:
receiving at least one data set, wherein the at least one data set pertains to the spatially local transportation infrastructure;
receiving at least one route definition from a user;
receiving at least one route constraint from the user;
providing the user an individualized transportation route with respect to at least one of the at least one route definition and the at least one route constraint, wherein the transportation route is cohesive with a macro scale transportation solution; and
optionally providing the user an adjusted individualized transportation route in response to a change in at least one route constraint or in response to a change in the at least one data set.

2. The method of claim 1 further comprising providing the individualized transportation route without a user providing at least one route definition.

3. The method of claim 1 further comprising providing the individualized transportation route without a user providing at least one route constraint.

4. The method of claim 1 wherein the at least one data set pertaining to the spatially local transportation infrastructure includes data pertaining to at least one of a freeway segment, a highway segment, a surface street segment, a bicycle lane segment, a pedestrian walkway segment, a traffic light, a metering light, and a public transportation unit.

5. The method of claim 4 wherein data pertaining to a freeway segment, a highway segment, a surface street segment, a bicycle lane segment or a pedestrian walkway segment includes one of at least the speed limit of the segment, the traffic density of the segment, and the conditions of the segment.

6. The method of claim 4 wherein the data pertaining to a traffic light or metering light includes at least one of the cycle duration of the light.

7. The method of claim 4 wherein the data pertaining to a public transportation unit includes at least one of the route of a unit, the departure time of a unit, the arrival time of a unit, and the density of use of a unit.

8. The method of claim 1 wherein the at least one data set may include at least one of current data, and predicted data.

9. The method of claim 1 wherein the macro scale of scope includes at least one of a traffic jurisdiction, such as a precinct, a town, a city, a municipality, a county, a state and a province.

10. The method of claim 1 wherein the transportation solution includes maximizing the efficiency of the transportation infrastructure.

11. The method of claim 1 wherein route definition includes at least one of a starting location, an ending location, and a waypoint location.

12. The method of claim 1 wherein the route constraints include at least one of a route timing preference, and a route personal preference.

13. The method of claim 12 wherein the route timing preference includes at least one of an ideal route start time, an ideal route start time window, an ideal route end time, an ideal route end time window, and a route duration.

14. The method of claim 12 wherein the route personal preference includes at least one of a choice to use the user's personal mode of transportation, a choice to carpool with another user, a choice to use public transportation, a choice to exclusively use a user's personal mode of transportation, a choice to exclusively use public transportation, and an amount the user is willing to pay on a route.

15. The method of claim 1 wherein cohesion with the traffic solution includes minimizing the number of individual routes intersecting temporally and spatially.

16. A computerized, centralized, customizable, connected traffic routing system configured to control a transportation infrastructure in real time on the macro scale, the traffic routing system configured to:
receive at least one data set, wherein the at least one data set pertains to the spatially local transportation infrastructure;
receive at least one route definition from a user;
receive at least one route constraint from the user;
provide the user with an individualized transportation route with respect to at least one of the at least one route definition and the at least one route constraint, wherein the transportation route is cohesive with a macro scale transportation solution; and
optionally provide the user with an adjusted individual transportation route in response to a change in at least one route constraint or in response to a change in the at least one data set.

17. The traffic routing system of claim 16 wherein the at least one data set pertaining to the spatially local transportation infrastructure includes data pertaining to at least one of a freeway segment, a highway segment, a surface street segment, a bicycle lane segment, a pedestrian walkway segment, a traffic light, a metering light, and a public transportation unit.

18. The traffic routing system of claim 17 wherein data pertaining to a freeway segment, a highway segment, a surface street segment, a bicycle lane segment or a pedestrian walkway segment includes one of at least the speed limit of the segment, the traffic density of the segment, and the conditions of the segment.

19. The traffic routing system of claim 16 wherein the route constraints include at least one of a route timing preference, and a route personal preference.

20. The traffic routing system of claim 19 wherein the route personal preference includes at least one of a choice to use the user's personal mode of transportation, a choice to carpool with another user, a choice to use public transportation, a choice to exclusively use a user's personal mode of transportation, a choice to exclusively use public transportation, and a bid amount a user is willing to pay on a route.
